(19) United States
(12) Patent Application Publication
(10) Pub. No.: US 2012/0320197 A1
(43) Pub. Date: Dec. 20, 2012

(54) DRESSING ROOM REAR VIEW VIDEO SYSTEM

(75) Inventor: Mark WERTS, Los Angeles, CA (US)

(73) Assignee: BOOTY CAM LLC, Los Angeles, CA (US)

(21) Appl. No.: 13/163,318

(22) Filed: Jun. 17, 2011

(51) Int. Cl. H04N 7/18

(52) U.S. Cl. 348/143; 348/E07.085

(57) ABSTRACT

A dressing room rear-view video system having a video camera and display screen is provided. The display screen is on the same side as or integrated into the mirror and the camera is positioned in a corner or on a wall opposite the mirror. The video camera is a closed circuit camera in exclusive communication with the single display screen in the dressing room, and is configured to stream video images of the customer's rear end while they are trying on their clothes and looking in the mirror at their front view.

### BACKGROUND

1. Technical Field

The present invention relates to dressing rooms. More particularly, it relates to rear view video systems for dressing rooms configured to enable the customer to see how the clothes they are trying on look from behind.

2. Description of Related Art

Currently when a customer is trying on clothes in a retail establishment, they generally have a single mirror in the dressing room. This single mirror makes it next to impossible for the customer to get a clear view of what the clothes look like from their read side. Often, the customer twists in order to get a glimpse of what their potential new clothes look like from the rear.

In some instances, the customer may leave the dressing room (leaving there personal belongings) and seek a dual mirror that generally includes two or more mirrors arranged at an angle with respect to each other. These mirrors lessen the “twisting” requirement on the customer, yet still do not provide a clear, straight on rear view of the customer while they are trying on the clothes they are looking to purchase.

### SUMMARY OF THE INVENTION

It is therefore an aspect of the invention to provide the customer with the ability to see their back while trying on clothes in the dressing room of a retail establishment.

These and other aspects are achieved in accordance with an embodiment of the invention where the dressing room video system includes a video camera positioned within the dressing room at an optimal location for rear end viewing, and a display screen configured for viewing while a user is facing the mirror such that the video camera provides a rear view of the user's rear end (e.g., booty or butt) while they are trying on clothing.

In additional implementations, the display is integrated into the mirror such as a mirror TV. The camera is preferably positioned at 36-37 inches from the dressing room floor at an angle of 130-150 degrees relative to the mirror.

Other objects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is plan view of the dressing room rear view camera system according to a preferred embodiment of the invention;

FIG. 2 is a plan view of a mirror with embedded display in a dressing room according to an embodiment of the invention;

FIG. 3 is a top view of an exemplary dressing room showing a preferred implementation of the dressing room rear view camera system according to the invention;

FIG. 4 is a block schematic diagram of the dressing room video system according to an implementation of the invention; and

FIG. 5 is a block schematic diagram of the dressing room video system according to another implementation of the invention.

### DETAILED DESCRIPTION

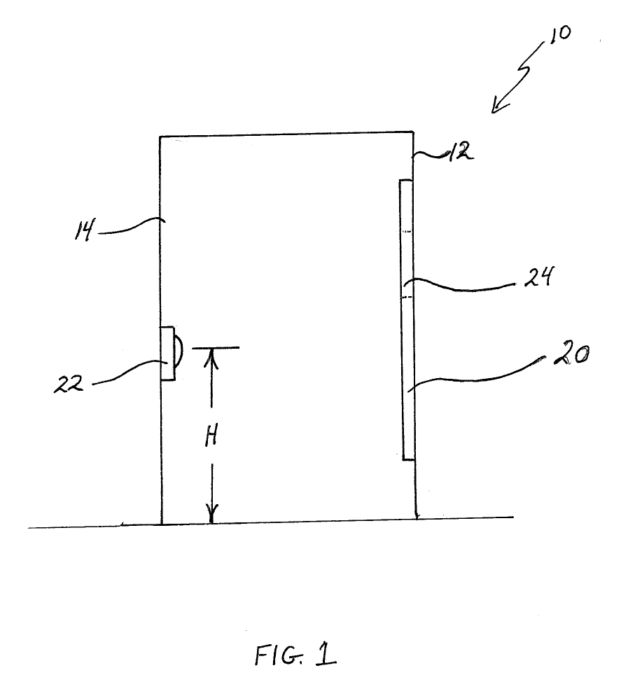

Referring to FIG. 1, there is shown an example of a dressing room 10 having at two opposing walls 12 and 14. In this embodiment, a mirror 20 is disposed on wall 12 to enable the use to see the clothes they are trying on from the front. In a preferred implementation a video camera 22 mounted on or in a corner opposing wall 12. In addition, in this embodiment, the mirror 20 includes an embedded video screen 24 (e.g., Mirror TV) which is in closed circuit communication with camera 22.

It is understood and appreciated that the use of video cameras in a dressing room contrary to the average person's expectations when entering a dressing room in a retail establishment. As such, the preferred embodiment of the present invention is designed and configured such that the camera 22 in a dressing room 10 is in exclusive closed circuit video communication with the one display device 24 in that particular dressing room 10.

For exemplary purposes, there are two types of Mirror TV's which can be used without departing from the scope of the invention. One example is a “screen” type mirror TV where when the display is off, the screen is black and can be seen on the mirror surface even though not in use. Another example is the “vanishing” type mirror TV where when the display is off, the user only sees a mirrored surface, thus the display vanishes into the mirror when off. Alternatively, the display 24 does not have to be part of, or integrated into the mirror, but could be simply placed over the mirror 20 or next to the same on the same wall 12. An example of a mirror TV is manufactured by a company by the name of SÉURA and referred to as “vanishing television mirrors”.

During operation, when the user tries on their clothes and looks in mirror 20 to see how they look from the front, they can simultaneously be provided with a streaming image of their rear view (e.g., a booty or butt view) via camera 22 and embedded display screen 24. This rear-view system provides a clear straight on view of the customer's rear end from behind, thus completely eliminating the need for the customer to twist or turn in an effort to get a peak at what their new clothes look like from behind. In an alternative embodiment, the camera can be a still image camera providing the user with still images of their rear view, rather than a streaming video moving pictures image. In another alternative embodiment, the controls 26 can include a button that enables the user to capture an image of streaming video and make it a still image (i.e., a freeze frame feature).

As will be evident, the position of the camera 22 within the dressing room is significant in order to achieve the desired effect and viewing of the customer's rear end. According to one embodiment, the camera 22 is positioned at height H which is preferably 37 inches from the floor. Those of skill in the art will appreciate that the specific height from the floor can be customized per location, but generally should be within a range of 36-48 inches from the floor.

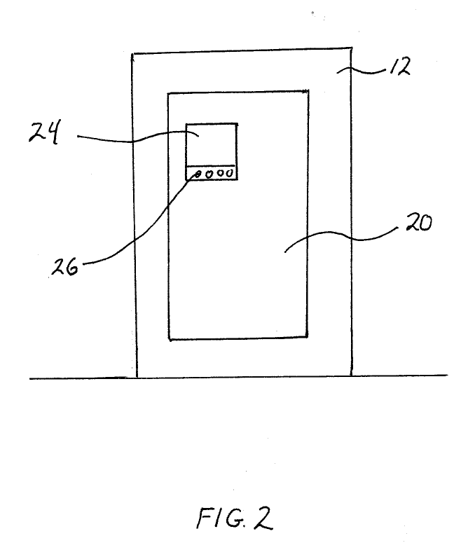

FIG. 2 shows an example of the mirror 20 on the wall 12 in the dressing room. In this example, the display screen 24 is integrated into the mirror (i.e., as a Mirror TV) so as to not interfere with the user's front viewing in the mirror yet provides a display window showing their rear-view. In alternative embodiments one or more camera controls 26 can be provided to allow the user to change the direction of the rear-view camera, or even just turn the camera on or off. For example these controls 26 could allow the user to move the camera up, down, left and right, and a power on/off control. The controls 26 are shown in this exemplary embodiment as part of the display 24, however controls 26 do not have to be positioned on the display 24 and can could be, for example, disposed on the wall next to the mirror 20.

The camera 22 is preferably a high resolution camera that is tamper proof and is configured to create a unique (straight on) view of the customer's rear end (at a predetermined distance) while not being positioned directly behind the customer's rear end in the dressing room. One example of a preferred camera 22 for use by the present invention includes the VITEK VTC-EL52H vandal and weather resistant elevator camera having the requisite lighting and other specifications for the present application. Of course, those of skill in the art will appreciate that other cameras may be implemented without departing from the intended scope of the present disclosure.

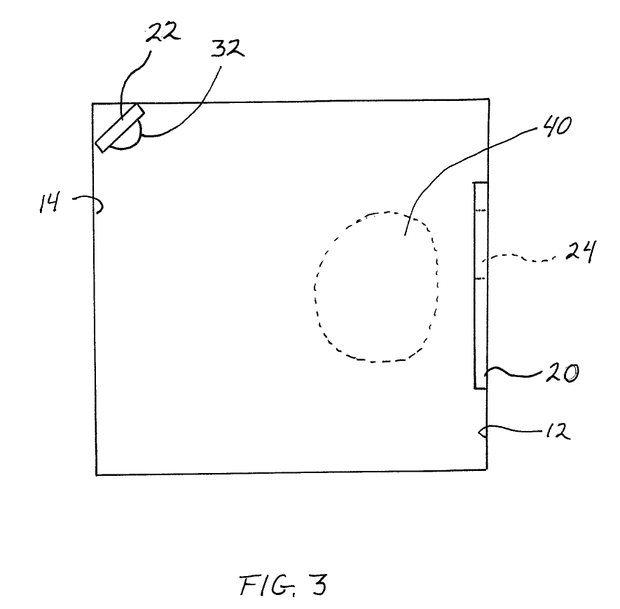

As shown in FIG. 3, the customer generally stands at a position shown indicated by 40, and the camera 22 is preferably positioned in a corner of the dressing room that is opposite the mirror 20. The camera 22 includes a lens (not shown) which is internal to the housing and is preferably a zoom lens. In addition, the camera includes an outer fish eye like lens cover 32 such that during operation, the zoom lens, in conjunction with the fish eye lens cover 32 creates a view that appears as if it is coming from an angle directly behind the customer (e.g., 180 degrees opposite the mirror) and yet is positioned in the corner, angularly displaced from a position directly opposite from the mirror 20. By using a zoom lens with the fish eye lens cover, the size of the dressing room is exaggerated thus creating a tighter view on the focal point which is the customer's rear end.

In accordance with a preferred implementation, due to the unique placement of the camera located in a range of 130-150 degrees from the mirror, the system of the invention is capable of creating an optimal rear view of the customer's back side. The height of the camera at a preferred 36″-37″ from the dressing room floor makes the dressing room look larger and the customer's back side to appear to be tighter in the mirror. With the fish eye lens over the zoom lens the present invention is capable of creating a tighter picture on the focal point of the camera.

The ability to provide the customer with a real time view of their rear side while trying on clothes has many different applications in different retail establishments (i.e., depending on the type of clothing being purchased). It is particularly applicable in stores that sell denim jeans, as customers often want to see what their rear end looks like in the new jeans they are seeking to purchase. As will be appreciated, other examples of applications for this invention can include, but are not limited to wedding gowns, bathing suits, maternity clothes, etc.

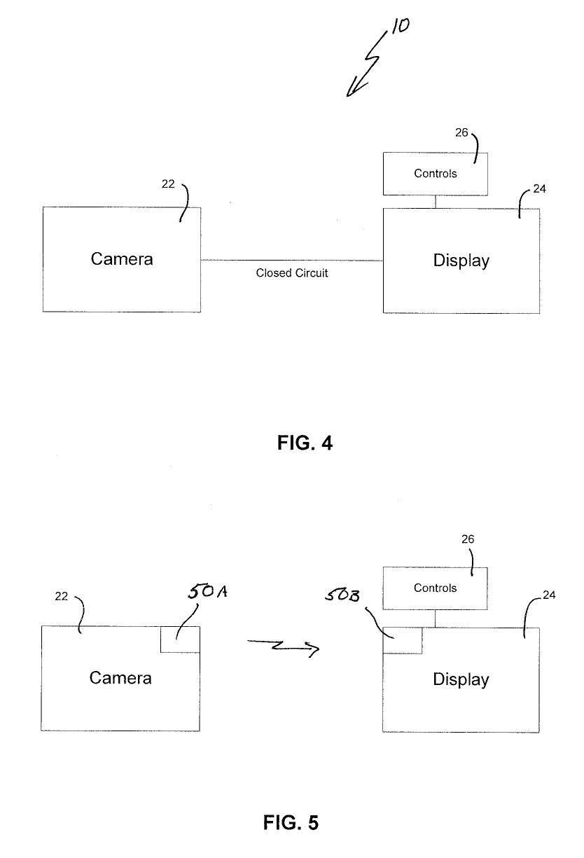

FIGS. 4 and 5 show schematic block diagrams of the dressing room rear view video system according to the present invention. FIG. 4 shows the camera 22 being in closed circuit connection with the display 24, where such connection is hardwired using any suitable cables or wires for such connection. As explained above, controls 26 can be included to provide various additional features to the rear view camera system such as, for example, the ability to turn the display on or off, the ability to freeze the frame on the display, move the camera lens direction, etc. In this respect, it is contemplated herein that controls 26 can also include processing capability, and associated memory or storage means necessary to operate the system and provide any additional features for the customer experience.

FIG. 5 shows an embodiment of the invention where the closed circuit connection between the camera 22 and the display 24 is performed wirelessly. This wireless closed circuit communication preferably uses a secure wireless protocol that has security measures to enable exclusive communication between the camera and its corresponding display. In this example, the camera 22 and display 24 include a wireless communication interface 50a and 50b, respectively. Those of skill in the art will appreciate that the type of wireless communication protocol implemented by the wireless interfaces can vary without departing from the scope of the present invention.

Controls 26 and/or display 24 can include a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

By way of example, display 24 could be a touch screen display or a tablet like device having significant processing capability (e.g., the iPAD® which is a registered trademark of Apple corporation). In this implementation controls 26 are not only integrated into to the display as touch screen features, the tablet display can be provided with applications that enable the user to perform various actions on the display of their rear end (or front view for that matter) and the clothing they are wearing. Examples of such applications could be, but are not limited to, changing the color of the clothing, changing the view to show what different “fits” (e.g., straight leg, relaxed, etc) may be available and what they would look like would look like, changing the manufacturer (brand) of product being worn, and even showing the customer what the clothing would look like if they lost or gained weight, etc.

Those of skill in the art will appreciate that new applications are being developed all the time for touch screen tablet and computer like display devices. As such, any and all applications, either currently developed or to be developed in the future that relate to the present invention display system can be included in the same with departing from the intended scope of the invention.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A dressing room video system comprising:
a video camera positioned to view a user's rear while they are facing a mirror within the dressing room; and
a display screen configured for viewing while a user is facing the mirror such that the video camera provides a rear view of the user while they are facing the mirror.

2. The dressing room video system of claim 1, wherein said display screen is integrated into the mirror.

3. The dressing room video system of claim 1, wherein the camera is positioned in a corner opposite the mirror.

4. The dressing room video system of claim 1, wherein the camera further comprises:
a tamperproof housing;
a fish eye lens cover; and
a zoom lens.

5. The dressing video system of claim 1, further comprising control means configured to allow the user to turn the camera on or off.

6. The dressing room video system of claim 1, further comprising control means configured to allow the user to move the camera direction.

7. The dressing room video system of claim 3, wherein the video camera is positioned in a range of 130-150 degrees from the mirror.

8. The dressing room video system of claim 1, wherein the video camera is positioned between 36-37 inches from a floor of the dressing room.

9. The dressing room video system of claim 1, further comprising control means configured to allow the user to capture a still image of streaming video images provided by the camera to the display.

10. A dressing room camera system comprising:
a closed circuit camera positioned to view a user's back side while they are facing a mirror on a wall within the dressing room; and
a closed circuit display screen connected exclusively to the closed circuit camera and being configured to enable a user to view images of their back side generated by the closed circuit camera while facing the mirror.

11. The dressing room camera system of claim 10, wherein the camera further comprises:
a tamperproof housing;
a fish eye lens cover; and
a zoom lens.

12. The dressing room camera system of claim 9, wherein the camera is positioned between 36-37 inches from a floor of the dressing room.

13. The dressing room camera system of claim 1, wherein the camera is positioned in a corner opposite the mirror at an angle in a range of 130-150 degrees with respect to the mirror.
